(19) United States
(12) Patent Application Publication
(10) Pub. No.: US 2002/0185218 A1
(43) Pub. Date: Dec. 12, 2002

(54) Molded article and method of bonding same

(75) Inventor: Masahiro Nakamichi, Chiba (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: IDEMITSU PETROCHEMICAL CO., LTD., Tokyo (JP)

(21) Appl. No.: 10/121,607

(22) Filed: Apr. 15, 2002

(30) Foreign Application Priority Data
Apr. 18, 2001 (JP) 2001-119212

(51) Int. Cl. B32B 31/00

(52) U.S. Cl. 156/272.2

(57) ABSTRACT

There is disclosed a method of bonding a molded article to at least one member selected from a group consisting of an epoxy resin, a silicone resin, a urethane resin, a paint, a pressure-sensitive adhesive and an enzyme. The method comprises providing a molded article made by the molding of a resin composition containing not less than 5 wt. % of a styrene polymer having highly a syndiotactic structure, subjecting the molded article to a surface treatment by ultraviolet irradiation; and bonding the surface-treated molded article to at least one member listed above.

### BACKGROUND OF THE INVENTION

1. Field of the Invention

The present invention relates a molded article and a method of bonding it. Specifically, the present invention relates to a molded article in which the adhesive strength is not reduced with time and thus the adhesive strength can be maintained for a long time, and a method of bonding such a molded article.

2. Description of the Related Art

Conventionally, when one tries to bond plastics, such as polystyrene, polyethylene, etc., to other materials, a surface treatment, such as ultraviolet treatment, plasma treatment, ozone treatment, flame treatment and corona treatment, may be applied to the surfaces of the plastics for the purpose of improving the adhesive strength thereof.

However, the adhesive strength of the plastics, such as polystyrene, polyethylene, etc., is reduced with time even if the surface treatment is applied. Hence, such plastics must be bonded to other materials immediately after the surface treatment, resulting in troublesome operations.

### SUMMARY OF THE INVENTION

In view of the foregoing, the present invention has been made to solve the above-mentioned problem, and it is an object of the present invention to provide a molded article in which the adhesive strength is not reduced with time and thus the adhesive strength can be maintained for a long time, and a method of bonding such a molded article.

The inventor of the present invention has found, through extensive researches and studies in order to achieve the above-mentioned object, that the adhesive strength can be improved by using a molded article made by the molding of a resin composition which contains not less than 5 wt. % of a styrene polymer having highly a syndiotactic structure, and subjecting the molded article to a surface treatment by ultraviolet irradiation. The present invention has been made based on the above finding.

Specifically, the present invention provides a molded article comprising a resin composition which contains not less than 5 wt. % of a styrene polymer having highly a syndiotactic structure, wherein the molded article has a surface which has been surface-treated by ultraviolet irradiation.

Further, the present invention provides a method of bonding a molded article to at least one member selected from a group consisting of an epoxy resin, a silicone resin, a urethane resin, a paint, a pressure-sensitive adhesive and an enzyme, wherein it comprises providing a molded article made by the molding of a resin composition containing not less than 5 wt. % of a styrene polymer having highly a syndiotactic structure, subjecting the molded article to a surface treatment by ultraviolet irradiation; and bonding the surface-treated molded article to at least one member listed above.

### BRIEF DESCRIPTION OF THE DRAWINGS

FIG. 1 is a graph showing the change in the adhesive strength of the molded article according to the present invention with respect to the change in the amount of ultraviolet irradiation.

### DETAILED DESCRIPTION OF THE PREFERRED EMBODIMENTS

The molded article according to the present invention comprises a resin composition which contains not less than 5 wt. % of a styrene polymer (i.e., SPS) having highly a syndiotactic structure.

If the content of SPS is less than 5 wt. %, there cannot be obtained stability with respect to change of the adhesive strength with time.

The syndiotactic structure in SPS as referred to herein means a stereostructure in which the stereochemical structure of SPS is a syndiotactic configuration, that is, phenyl groups constituting the side chains are positioned alternately on opposite sides with respect to the main chain composed of carbon-carbon linkages. The tacticity is quantified by the nuclear magnetic resonance method using isotopic carbon atoms (i.e., ¹³C—NMR method). The tacticity as measured by ¹³C—NMR method is indicated by the proportion of a building block consisting of a plurality of base units, for example, a diad in the case where the building block consists of two base units, a triad in the case where the building block consists of three base units, and a pentad in the case where the building block consists of five base units. Examples of SPS used in the present invention include polystyrene, poly(alkyl styrene), poly(aryl styrene), poly(halogenated styrene), poly(halogenated alkyl styrene), poly(alkoxy styrene), poly(vinyl benzoate), hydrogenated polymers thereof, mixtures thereof and copolymers each comprising any of these as a main component, all having a syndiotacticity of generally 75% or more, preferably 85% or more, in terms of racemic diads, or 30% or more, preferably 50% or more, in terms of racemic pentads.

Examples of poly(alkyl styrene) include poly(methyl styrene), poly(ethyl styrene), poly(isopropyl styrene), poly(tertiary butyl styrene), etc. Examples of poly(aryl styrene) include poly(phenyl styrene), poly(vinyl naphthalene), poly(vinyl styrene), etc. Examples of poly(halogenated styrene) include poly(chlorostyrene), poly(bromostyrene), poly(fluorostyrene), etc. Examples of poly(halogenated alkyl styrene) include poly(chloromethyl styrene), etc. Examples of poly(alkoxy styrene) include poly(methoxy styrene), poly(ethoxy styrene), etc.

Examples of preferred styrene polymers include polystyrene, poly(p-methyl styrene), poly(m-methyl styrene), poly(p-tertiary-butyl styrene), poly(p-chlorostyrene), poly(m-chlorostyrene), poly(p-fluorostyrene), hydrogenated polystyrene, and copolymers having those structural units.

SPS can be produced by, for example, polymerizing styrene monomers corresponding to the above-described styrene polymers, using a condensation product of (i) a titanium compound and water and (ii) a trialkyl aluminum as a catalyst, in an inert hydrocarbon solvent or in the absent of any solvent, as described in Japanese Patent Application Laid-open (kokai) No. 62(1987)-187708. Further, poly(halogenated alkyl styrene) can be obtained by, for example, the method described in Japanese Patent Application Laid-open (kokai) No. 1(1989)-46912, and hydrogenated polymers thereof can be obtained by, for example, the method described in Japanese Patent Application Laid-open (kokai) No. 1(1989)-178505.

The resin composition containing not less than 5 wt.% of SPS as used in the present invention may include, in addition to SPS, (1) a rubber-like elastic material, (2) a thermoplastic resin other than SPS and (3) various kinds of additives. Kneading of these components may be carried out in various ways, such as the way in which such components are blended, and then melted and kneaded in a certain step during the syndiotactic polystyrene production process, the way in which respective components making up the resin composition are blended, and then melted and kneaded, and the way in which the above components are dry-blended at the time of the molding, and then kneaded in the extruder of the molding machine. The mold temperature at the molding is preferably 100° C. or lower, and is more preferably 80° C. or lower.

(1) Examples of the rubber-like elastic material which may be used in the present invention include natural rubber, polybutadiene, polyisoprene, polyisobutylene, neoprene, polysulfide rubber, Thiokol rubber, acrylic rubber, urethane rubber, silicone rubber, epichlorohydrin rubber, a styrene-butadiene block copolymer (SBR), a hydrogenated styrene-butadiene block copolymer (SEB), a styrene-butadiene-styrene block copolymer (SBS), a hydrogenated styrene-butadiene-styrene block copolymer (SEBS), a styrene-isoprene block copolymer (SIR), a hydrogenated styrene-isoprene block copolymer (SEP), a styrene-isoprene-styrene block copolymer (SIS), a hydrogenated styrene-isoprene-styrene block copolymer (SEPS), olefin rubbers, such as ethylene propylene rubber (EPM), ethylene propylene diene rubber (EPDM) and straight-chain low-density polyethylene elastomers, particulate elastic materials of core shell type, such as butadiene-acrylonitrile-styrene core shell rubber (ABS), methyl methacrylate-butadiene-styrene core shell rubber (MBS), methyl methacrylate-butyl acrylate-styrene core shell rubber (MAS), octyl acrylate-butadiene-styrene core shell rubber (MABS), alkyl acrylate-butadiene-acrylonitrile-styrene core shell rubber (AABS), butadiene-styrene core shell rubber (SBR) and siloxane-containing core shell rubbers, such as those of methyl methacrylate-butyl acrylate-siloxane, and their modified rubbers.

(2) Examples of the thermoplastic resin other than SPS which may be used in the present invention include polyolefin resins, such as straight-chain high-density polyethylene, straight-chain low-density polyethylene, high-pressure low-density polyethylene, isotactic polypropylene, syndiotactic polypropylene, block polypropylene, random polypropylene, polybutene, 1,2-polybutadiene, 4-methyl pentene, cyclic polyolefins, and copolymers thereof, polystyrene resins, such as atactic polystyrene, isotactic polystyrene, HIPS, ABS, AS, a styrene-methacrylic acid copolymer, a styrene-alkyl methacrylate copolymer, a styrene-glycidyl methacrylate copolymer, a styrene-acrylic acid copolymer, a styrene-alkyl acrylate copolymer, a styrene-maleic acid copolymer and a styrene-fumaric acid copolymer; polyester resins, such as polycarbonate, polyethylene terephthalate and polybutylene terephthalate; polyamide resins, such as polyamide 6 and polyamide 6, 6; polyphenylene ethers; PPS; and the like. These thermoplastic resins may be used singly or in combination.

(3) Examples of the various kinds of additives which may be used in the present invention include an anti-blocking agent, an anti-oxidant, a nucleating agent, an antistatic agent, a process oil, a plasticizer, a releasing agent, a flame-retardant, a flame-retarding assistant, a pigment, etc, as long as they do not obstruct the object of the present invention. There is no specific limitation on the amount at which these additives are incorporated into the resin composition, and the amount may be decided according to a particular application of the molded article made of the resin composition.

Examples of the anti-blocking agent include those of the types of, for example, inorganic and organic particles.

Examples of the inorganic particle include particles of oxides, hydroxides, sulfides, nitrides, halides, carbonates, sulfates, acetates, phosphates, phosphites, organic carboxylates, silicates, titanates and borates of elements of I A Group, II A Group, IV A Group, VI A Group, VII A Group, VIII Group, I B Group, II B Group, III B Group and IV B Group of the Periodic Table, hydrous compounds thereof, composite compounds having centers composed thereof; and particles of natural minerals.

Specifically, examples of the inorganic particle include particles of compounds of I A Group elements of the Periodic Table, such as lithium fluoride and borax (hydrous sodium borate); particles of compounds of II A Group elements of the Periodic Table, such as magnesium carbonate, magnesium phosphate, magnesium oxide (magnesia), magnesium chloride, magnesium acetate, magnesium fluoride, magnesium titanate, magnesium silicate, hydrous magnesium silicate (talc), calcium carbonate, calcium phosphate, calcium phosphite, calcium sulfate (gypsum), calcium acetate, calcium terephthalate, calcium hydroxide, calcium silicate, calcium fluoride, calcium titanate, strontium titanate, barium carbonate, barium phosphate, barium sulfate and barium sulfite; particles of compounds of IV A Group elements of the Periodic Table, such as titanium dioxide (titania), titanium monoxide, titanium nitride, zirconium dioxide (zirconia) and zirconium monoxide; particles of compounds of VI A Group elements of the Periodic Table, such as molybdenum dioxide, molybdenum trioxide and molybdenum sulfide; particles of compounds of VII A Group elements of the Periodic Table, such as manganese chloride and manganese acetate; particles of compounds of VIII Group elements of the Periodic Table, such as cobalt chloride and cobalt acetate; particles of compounds of I B Group elements, such as cuprous iodide; particles of compounds of II B Group elements of the Periodic Table, such as zinc oxide and zinc acetate; particles of compounds of III B Group elements of the Periodic Table, such as aluminum oxide (alumina), aluminum hydroxide, aluminum fluoride and alumina silicate (alumina silicate, kaolin, kaolinite); particles of compounds of IV B Group elements of the Periodic Table, such as silicon oxide (silica, silica gel), black lead, carbon, graphite and glass; and particles of natural minerals, such as carnallite, kainite, mica (mica, phlogopite) and pyrolusite.

Examples of the organic particle include Teflon™, melamine resins, a styrene-divinyl benzene copolymer, acrylic resin silicone, and crosslinked derivatives thereof.

The average particle diameter of the inorganic particles is preferably in the range of 0.1 μm-10 μm. The amount at which the inorganic particles are incorporated into the resin composition is preferably in the range of 0.01 wt. %-15 wt. %.

These inorganic fillers may be used singly or in combination.

The antioxidant which may be used in the present invention can be arbitrarily selected from known antioxidants, such as those of phosphorus type, phenol type, sulfur type, and the like. Specifically, 2-[1-hydroxy-3, 5-di-(t-pentyl phenyl) ethyl]-4, 6-di-t-pentyl phenyl acrylate may be used as the antioxidant. The antioxidants may be used singly or in combination.

The nucleating agent which may be used in the present invention can be arbitrarily selected from known nucleating agents, such as metal salts of carboxylic acids, such as aluminum di-(p-t-butyl benzoate); metal salts of phosphoric acids, such as methylene-bis-(2,4-di-t-butyl phenol) acid sodium phosphate; talc; phthalocyanine derivatives; and the like. The nucleating agents may be used singly or in combination.

The plasticizer which may be used in the present invention can be arbitrarily selected from known plasticizers, such as polyethylene glycol, polyamide oligomers, ethylene-bis-stearamide, phthalic esters, a polystyrene oligomer, polyethylene wax, silicone oil, and the like. The plasticizers may be used singly or in combination.

The releasing agent which may be used in the present invention can be arbitrarily selected from known releasing agents, such as polyethylene wax, silicone oil, long chain carboxylic acids, metal salts of long chain carboxylic acids, and the like. The releasing agents may be used singly or in combination.

In the present invention, it is required to subject a molded article comprising a resin composition which contains not less than 5 wt. % of the above-mentioned SPS to a surface treatment by ultraviolet irradiation.

With the exposure to ultraviolet rays, polar groups, such as —COOH, —COH, —C═O and —OH, are formed at the surface of the molded article due to the radical generation in the molecules of the resin at the surface of the molded article and the generation of active oxygen derived from oxygen in the air surrounding the molded article. The polar groups react with an adhesive or exhibit strong affinity with respect to an adhesive, so that the adhesiveness between the adhesive and the molded article can be improved, resulting in enhancement in the adhesive strength of the molded article. For example, in the case where the adhesive is a silicone adhesive, the polar groups are hydrogen-bonded to the oxygen atoms in the silicone of the silicone adhesive and further react with the functional groups in the silicone adhesive. On the other hand, in the case where the adhesive is an epoxy adhesive, the polar groups react with the epoxy groups of the epoxy adhesive.

The surface treatment by the ultraviolet irradiation can be carried out using any irradiation apparatus as long as the apparatus has an ultraviolet light source which can emit light in the ultraviolet wavelength range (i.e., wavelengths shorter than 400 nm) in a sufficient amount of irradiation required to improve the adhesiveness between the adhesive and the molded article. Specifically, the amount of irradiation of the ultraviolet light is preferably in the range of 50-10,000 mJ/cm². If the amount of irradiation of the ultraviolet light is less than 50 mJ/cm², no improvement can be obtained in the adhesive strength of the molded article. On the other hand, if the amount of irradiation of the ultraviolet light exceeds 10,000 mJ/cm², no further improvement can be obtained as compared with that in the case of 10,000 mJ/cm² (the degree of improvement reaches the maximum when the amount of irradiation of the ultraviolet light is 10,000 mJ/cm²), and excessive amounts of irradiation of the ultraviolet light will cause deterioration of the resin, which is not desirable.

Examples of the ultraviolet light source include discharge tubes, such as those of hydrogen, rare gas, mercury, etc., and laser sources, such as those of nitrogen laser, cadmium laser, xenon excimer laser, hydrogen laser, etc. Light sources having powers of 1 kw or more are preferred in view of restrictions on the irradiation time and the like. In practicing the present invention, irradiation apparatuses which have the above-explained light sources and sizes to correspond to the sizes of the molded articles may be used. The irradiation apparatuses are preferably those in each of which the position of the light source, the direction in which the light source faces, the intensity of the light to be emitted by the light source, etc. can be adjusted steplessly. Further, from the viewpoint of safety and workability, the irradiation apparatuses are preferably provided with conveyors to convey the molded articles and cooling devices.

When surface treatment in a partial manner is to be carried out, selective exposure to the ultraviolet rays can be effected, using ultraviolet laser and/or masking technique.

With the surface treatment by the ultraviolet irradiation, improvement can be obtained in the, adhesiveness with respect to epoxy, silicone and urethane resins, adhesives, and paints; and in the affinity with respect to enzymes in the biochemical field.

The exposure to the ultraviolet rays is advantageous because there is no attenuation in the effect of the treatment with time, and thus it is unnecessary to carry out subsequent steps, such as a bonding step, immediately after the surface treatment, so that handling and process control is easy.

The amount of irradiation of the ultraviolet light must be appropriately adjusted, depending on the loading amount of the antioxidant and/or the flame-retardant. In this respect, it is necessary that the amount of irradiation of the ultraviolet light should be set at a relatively high level in cases where the loading amount of the antioxidant is high.

Further, the amount of irradiation of the ultraviolet light may be appropriately adjusted, depending on the conditions under which the resin composition is molded into the molded article. In this respect, in cases where the molding is performed using low-temperature molds, sufficient adhesive strength can be obtained even with small amounts of irradiation of the ultraviolet light.

The present invention will hereinbelow be described in further detail with reference to the following examples, but the present invention is not limited to such examples.

### EXAMPLE 1

Bars having dimensions of 125 mm×12.7 mm×1.6 mm were prepared, using a resin composition which comprises 60 wt. % of SPS having a syndiotacticity of 98% in the racemic pentad therein, 30 wt. % of glass fiber and 10 wt. % of SEBS (i.e., Product Name: S131 available from Idemitsu Petrochemical Co., Ltd.), under the conditions that the mold temperature was 60° C. and the cylinder temperature was 290° C. The prepared bars were subjected to the surface treatment using an ultraviolet curing machine available from Eye Graphics Co. Ltd. and a high-pressure mercury lamp of 120 w as the light source, with the amount of irradiation being each one of 50 mJ/cm², 150 mJ/cm², 300 mJ/cm² and 620 mJ/cm², and with the irradiation distance being 150 mm. Immediately after the surface treatment, the treated surfaces of the surface-treated bars thus obtained were coated with a silicone adhesive, TSE 322 available from Toshiba Silicone Corporation, in such a manner that the coated surface area for each bar was 1.2 cm² and the thickness of the coating was 200 μm, followed by curing at 1 50° C. for one hour. Then, the surface-treated bars coated with the silicone adhesive as cured were each subjected to a peel test to measure the adhesive strength thereof. The peel test was performed by the tensile shear test according to JIS (Japanese Industrial Standards) K-6911.

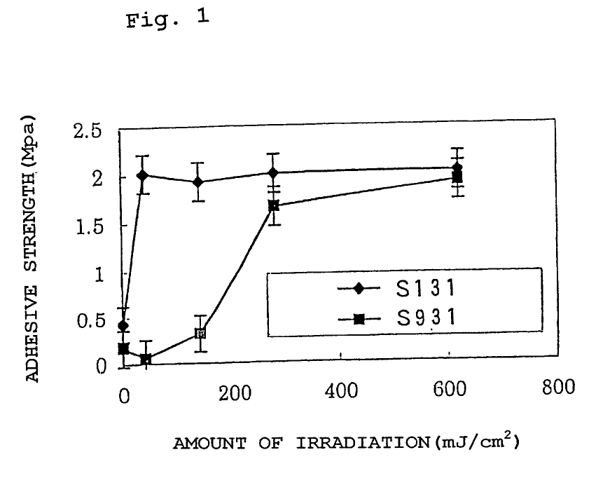

The test results revealed that the adhesive strengths of the articles for the amounts of irradiation of 50 mJ/cm², 150 mJ/cm², 300 mJ/cm² and 620 mJ/cm² were 2.0 MPa, 1.9 MPa, 2.0 MPa and 2.0 MPa, respectively. These results are shown in FIG. 1.

### COMPARATIVE EXAMPLE 1

A molded article was prepared through the same procedures as in Example 1 except that the surface treatment by the ultraviolet irradiation was not carried out, and was subjected to the peel test to measure the adhesive strength thereof.

The test results revealed that the adhesive strength of this article was 0.4 MPa. This is also shown for 0 mJ/cm² in FIG. 1.

### EXAMPLE 2

Molded articles were prepared through the same procedures as in Example 1 except that a resin composition was used, in place of the resin composition S131, which comprises 45 wt. % of SPS, 15 wt. % of a flame-retardant, 30 wt. % of glass fiber and 15 wt. % of SEBS (i.e., Product Name: S931 available from Idemitsu Petrochemical Co., Ltd.), and were each subjected to the peel test to measure the adhesive strength thereof.

The test results revealed that the adhesive strengths of the articles thus obtained for the amounts of irradiation of 50 mJ/cm², 150 mJ/cm², 300 mJ/cm² and 620 mJ/cm² were 0.2 MPa, 0.4 MPa, 1.6 MPa and 1.9 MPa, respectively. These results are shown in FIG. 1.

### COMPARATIVE EXAMPLE 2

A molded article was prepared through the same procedures as in Example 2 except that the surface treatment by the ultraviolet irradiation was not carried out, and was subjected to the peel test to measure the adhesive strength thereof.

The test results revealed that the adhesive strength of this article was 0.2 MPa. This is also shown for 0 mJ/cm² in FIG. 1.

### EXAMPLE 3

Bars similar to those in Example 1 were prepared, using a resin composition which comprises 80 wt. % of SPS and 20 wt. % of SEBS (i.e., Product Name: S104 available from Idemitsu Petrochemical Co., Ltd.), under the conditions that the mold temperature was 70° C. and the cylinder temperature was 280° C. The prepared bars were subjected to the surface treatment using an ultraviolet curing machine available from Eye Graphics Co. Ltd. and a high-pressure mercury lamp of 120 w as the light source, with the amount of irradiation being each one of 715 mJ/cm², 1430 mJ/cm² and 2860 mJ/cm², and with the irradiation distance being 150 mm. Immediately after the surface treatment, the treated surfaces of the surface-treated bars thus obtained were coated with an epoxy adhesive, SR 25/SH 25 available from Nippon Synthetic Chemical Industry Co., Ltd, in such a manner that the coated surface area for each bar was 1.2 cm² and the thickness of the coating was 200 μm, followed by curing at 70° C. for four hours and then at 120° C. for eight hours.

Then, the surface-treated bars coated with the epoxy adhesive as cured were each subjected to the tensile shear test according to JIS K-6911 to measure the adhesive strength thereof and to inspect the state of each released surface. The results are shown in Table 1.

### COMPARATIVE EXAMPLE 3

A molded article was prepared through the same procedures as in Example 3 except that the surface treatment by the ultraviolet irradiation was not carried out, and was subjected to the tensile shear test to measure the adhesive strength thereof and to inspect the state of the released surface. The results are shown in Table 1.

TABLE 1

| Amount of Irradiation | Adhesive Strength | |
|---|---|---|
| (mJ/cm²) | (MPa) | State of Released Surface* |
| 715 | 1.5 | x-Δ |
| 1430 | 3.0 | ∘ |
| 2860 | 7.0 | ∘ |
| No Irradiation | 0.4 | X |

Note: *State of Released Surface
∘: The interface between the molded article and the coating was destroyed.
Δ: Peeling occurred at the interface between the molded article and the coating, but the peeled surface of the molded article was roughened.
X: Peeling occurred at the interface between the molded article and the coating, and no changes were observed at the peeled surface of the molded article.

### EXAMPLE 4

Molded articles were prepared under the same conditions as those in Example 3. The prepared articles were subjected to the surface treatment using an ultraviolet curing machine available from Eye Graphics Co. Ltd. and a high-pressure mercury lamp of 120 w as the light source, with the amount of irradiation being each one of 500 mJ/cm², 1000 mJ/cm², 2000 mJ/cm² and 10000 mJ/cm², and with the irradiation distance being 150 mm. The surface of each of the surface-treated articles was inspected in such a manner that the infrared spectrum thereof was measured. As a result, the surface-treated articles for all the amounts of irradiation used exhibited peaks for polar groups of —COOH, —COH and —C═O at wavelengths in the range of 1650-1850 cm⁻¹ and a peak for a polar group of —OH at wavelengths in the range of 3000-3700 cm⁻¹.

### EXAMPLE 5

Molded articles were prepared under the same conditions as those in Example 3. The prepared articles were subjected to the surface treatment using an ultraviolet curing machine available from Eye Graphics Co. Ltd. and a high-pressure mercury lamp of 120 w as the light source, with the amount of irradiation being each one of 500 mJ/cm² and 1000 mJ/cm², and with the irradiation distance being 150 mm. Each one of immediately after, one hour after, and 30 days after the surface treatment, the treated surfaces of the surface-treated articles thus obtained were coated with a silicone adhesive, TSE 322 available from Toshiba Silicone Corporation, followed by curing at 150° C. for one hour. The adhesive strength of each of the articles thus obtained was measured. In this respect, the number of specimens for each subject to be measured was 10. The results of the measurements are shown in Table 2.

### COMPARATIVE EXAMPLE 4

Molded articles were prepared through the same procedures as in Example 5 except that the surface treatment by the ultraviolet irradiation was not carried out. Each one of immediately after, one hour after, and 30 days after the surface treatment, the surfaces of the non-surface-treated articles thus obtained were coated with a silicone adhesive, TSE 322 available from Toshiba Silicone Corporation, followed by curing at 150° C. for one hour. Then, the adhesive strength of each of the articles thus obtained was measured. The results of the measurements are shown in Table 2.

TABLE 2

| Amount of | Immediately After | One Hour After | 30 Days After |
|---|---|---|---|
| Irradiation | Irradiation | Irradiation | Irradiation |
| (mJ/cm²) | (MPa) | (MPa) | (MPa) |
| 500 | 2.0 ± 0.5 | 2.1 ± 0.2 | 1.9 ± 0.1 |
| 1500 | 2.4 ± 0.7 | 2.3 ± 0.2 | 2.3 ± 0.1 |
| No Irradiation | 0.2 ± 0.1 | 0.2 ± 0.1 | 0.2 ± 0.1 |

As can be seen from Table 2, the molded articles which have been subjected to the ultraviolet irradiation exhibit substantially no reduction or very small reduction if at all in the adhesive strength in comparing those to which a certain material, for example, the silicone adhesive in this particular case, has been applied immediately after the surface treatment, one hour after the surface treatment and 30 days after the surface treatment.

### EXAMPLE 6

Molded articles were prepared under the same conditions as those in Example 3. The prepared articles were subjected to the surface treatment using an ultraviolet curing machine available from Eye Graphics Co. Ltd. and a high-pressure mercury lamp of 120 w as the light source, with the amount of irradiation being each one of 500 mJ/cm² and 1500 mJ/cm², and with the irradiation distance being 150 mm. Each one of immediately after, one hour after, and 30 days after the surface treatment, the treated surfaces of the surface-treated articles thus obtained were coated with an epoxy adhesive, SR 25/SH 25 available from Nippon Synthetic Chemical Industry Co., Ltd., followed by curing at 70° C. for four hours and then 120° C. for eight hours. The adhesive strength of each of the articles thus obtained was measured. In this respect, the number of specimens for each subject to be measured was 10. The results of the measurements are shown in Table 3.

### COMPARATIVE EXAMPLE 5

Molded articles were prepared through the same procedures as in Example 6 except that the surface treatment by the ultraviolet irradiation was not carried out. Each one of immediately after, one hour after, and 30 days after the surface treatment, the surfaces of the non-surface-treated articles thus obtained were coated with an epoxy adhesive, SR 25/SH 25, followed by curing at 70° C. for four hours and then 120° C. for eight hours. Then, the adhesive strength of each of the articles thus obtained was measured. The results of the measurements are shown in Table 3.

TABLE 3

| Amount of | Immediately After | One Hour After | 30 Days After |
|---|---|---|---|
| Irradiation | Irradiation | Irradiation | Irradiation |
| (mJ/cm²) | (MPa) | (MPa) | (MPa) |
| 500 | 2.2 ± 1.0 | 2.5 ± 0.3 | 2.4 ± 0.2 |
| 1500 | 4.0 ± 1.0 | 4.2 ± 0.5 | 3.9 ± 0.3 |
| No Irradiation | 0.2 ± 0.1 | 0.2 ± 0.1 | 0.2 ± 0.1 |

As can be seen from Table 3, the molded articles which have been subjected to the ultraviolet irradiation exhibit substantially no reduction or very small reduction if at all in the adhesive strength in comparing those to which a certain material, for example, the epoxy adhesive in this particular case, has been applied immediately after the surface treatment, one hour after the surface treatment and 30 days after the surface treatment. Further, it is clear from Table 3 that variations in the adhesive strength between molded specimens which have been surface-treated under the same irradiation conditions are smaller as they are bonded to a certain material, for example, the epoxy adhesive in this particular case, longer time after the surface treatment.

As is explained in detail above, with the molded article and the method of bonding the molded article according to the present invention, it is no longer necessary to bond the molded article to other materials immediately after the surface treatment thereof, i.e., the ultraviolet irradiation, and the molded article can have high adhesive strength without any substantial variations when longer time lapses after the surface treatment. Thus, the ultraviolet irradiation can be applied to the treated surface of the molded article to improve adhesive strength with a silicone adhesive, an epoxy adhesive, printings, enzymes, etc..

What is claimed is:

1. A molded article comprising a resin composition which contains not less than 5 wt. % of a styrene polymer having highly a syndiotactic structure, wherein the molded article has a surface which has been surface-treated by ultraviolet irradiation.

2. A molded article according to claim 1, wherein the surface has been surface-treated by ultraviolet irradiation in the range of 50-10,000 mJ/cm².

3. A molded article according to claim 1, wherein it has been molded at a temperature of not higher than 100° C.

4. A molded article according to claim 1, wherein the styrene polymer having highly a syndiotactic structure is selected from the group consisting of polystyrene, poly(alkyl styrene), poly(aryl styrene), poly(halogenated styrene), poly(halogenated alkyl styrene), poly(alkoxy styrene), poly(vinyl benzoate), hydrogenated polymers thereof, mixtures thereof and copolymers each comprising any of these as a main component, all having a syndiotacticity of 75% or more of racemic diads, or 30% or more of racemic pentads.

5. A molded article according to claim 1, wherein the resin composition further contains a rubber-like elastic material, a thermoplastic resin other than the styrene polymer having highly a syndiotactic structure and/or additives.

6. A method of bonding a molded article to at least one member selected from a group consisting of an epoxy resin, a silicone resin, a urethane resin, a paint, a pressure-sensitive adhesive and an enzyme, said method comprising:
providing the molded article made by the molding of a resin composition containing not less than 5 wt. % of a styrene polymer having highly a syndiotactic structure,
subjecting the molded article to a surface treatment by ultraviolet irradiation; and
bonding the surface-treated molded article to said at least one member.

7. A method according to claim 6, wherein the bonding is performed not less than one hour after the surface treatment.

8. A method according to claim 6, wherein the styrene polymer having highly a syndiotactic structure is selected from the group consisting of polystyrene, poly(alkyl styrene), poly(aryl styrene), poly(halogenated styrene), poly(halogenated alkyl styrene), poly(alkoxy styrene), poly(vinyl benzoate), hydrogenated polymers thereof, mixtures thereof and copolymers each comprising any of these as a main component, all having a syndiotacticity of 75% or more of racemic diads, or 30% or more of racemic pentads.
